(19) United States
(12) Patent Application Publication
(10) Pub. No.: US 2010/0148602 A1
(43) Pub. Date: Jun. 17, 2010

(54) OIL RETAINER COOLING ASSEMBLY FOR AN ELECTRIC MOTOR

(75) Inventor: Efren S. Parra, Cd. Juarez (MX)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: DELPHI TECHNOLOGIES, INC., Troy, MI (US)

(21) Appl. No.: 12/333,374

(22) Filed: Dec. 12, 2008

(51) Int. Cl. H02K 9/06; H02K 5/16

(52) U.S. Cl. 310/63; 310/90

(57) ABSTRACT

An electric motor having an oil retainer cooling assembly fixed onto the motor shaft between the rotor assembly and support bearing within the motor housing. The retainer cooling assembly is a single piece unit used to retain oil in the support bearing and to induce air flow within the housing to internally cool the electric motor. The oil retainer cooling assembly includes a hub that has a bore for the insertion and attachment of the hub to the motor shaft, a surface in sealing contact with the bearing assembly, a plurality of fan blades protruding radially from the hub, and a shoulder between the hub surface and the fan blades. The oil retainer assembly rotates with the shaft during normal operating conditions, whereby the blades induces air flow within the housing to cool the electric motor and the hub surface maintains sealing contact with bearing assembly to retain oil within the bearing.

### TECHNICAL FIELD OF INVENTION

The invention relates to an electric motor having an oil retainer assembly; more particularly, an oil retainer assembly having fan blades for the cooling of an electric motor; still more particularly, an integrated oil retainer cooling assembly.

### BACKGROUND OF INVENTION

Electric motors have support bearings on either ends of the motor housing to support the motor shaft. Typically, each support bearing includes a cylindrical sleeve that is press fitted into an end of the motor housing. The cylindrical sleeve includes a bore to accommodate the support and rotation of the motor shaft. The support bearing may also be that of a more complex assembly that includes an outer member that is press fitted into an end of the motor housing, an inner member that is press fitted onto the motor shaft, and friction reducing members therebetween to allow the inner member to rotate freely with respect to the outer member. The support bearings are provided with an oil lubricant or a heavier bearing grease to enhance the life and performance of the support bearings.

The centrifugal force from the high rotation rate of the motor shaft causes the oil lubricant or grease to be thrown radially outward from the shaft. Grease thrown inboard of the motor housing may accumulate onto the motor windings of the rotor assembly and stator, which may eventually result in a short circuit or other circuit fault causing overheating and failure of the electric motor.

What is desired is an oil retainer to seal the oil or grease within the bearing to prevent the internal workings of the electric motor from being fouled. It is further desirable to maintain the seal on the bearing during high speed rotation of the motor shaft during normal operating conditions. It is also further desirable for the oil retainer to have means to cool the electric motor to improve durability.

### SUMMARY OF THE INVENTION

The present invention provides an electric motor assembly having an oil retainer cooling assembly fixed onto the motor shaft between the rotor assembly and support bearing within the motor housing. The oil retainer cooling assembly is a single integral unit used to retain oil in the support bearing and to induce air flow within the housing to internally cool the electric motor.

The electric motor assembly includes a substantially tubular housing with a first end and a second end opposite of the first end disposed about a longitudinal axis. A motor shaft disposed within the housing along the longitudinal axis. The motor shaft includes an output end extending from the first end of housing and a non-output end extending from the second end of housing in a direction opposite of the output end. A support bearing is fitted to the second end and includes a bore co-axial with the motor shaft for supporting the non-output end of the motor shaft. The support bearing assembly includes an oil lubricant to allow the motor shaft to rotate freely with respect to the motor housing. The electric motor assembly further includes a rotor assembly is fixed onto the motor shaft within the housing. Fixed onto the motor shaft between the rotor assembly and support bearing is an oil retainer cooling assembly. The oil retainer cooling assembly includes a hub that has a hub bore for the insertion and attachment of the hub to the motor shaft to allow the oil retainer cooling assembly to rotate with the shaft. Protruding radially from the hub is a plurality of fan blades. As the oil retainer assembly rotates with the shaft, the blades induce air flow within the housing, thereby cooling the motor assembly. The hub further includes a hub surface that is substantially perpendicular to the longitudinal axis and in sealing contact with the support bearing to retain the oil within the bearing.

An advantage of the present invention the is that the oil retainer cooling assembly retains the oil or heavier grease within the bearing to prevent the internal workings of the electric motor from being fouled and simultaneously cools the internal workings of the electric motor during normal operating conditions. Another advantage is that the oil retainer cooling assembly may be molded as a single piece unit. Still another advantage is that the oil retainer cooling assembly seals itself onto the support bearing with a sealing effectiveness proportional to the increase in speed of rotation of the motor shaft.

Further features and advantages of the invention will appear more clearly on a reading of the following detailed description of an embodiment of the invention, which is given by way of non-limiting example only and with reference to the accompanying drawings.

### BRIEF DESCRIPTION OF DRAWINGS

The invention will be better understood form the following detailed description of the embodiments thereof, taken in conjunction with the accompany drawings, wherein like reference numerals refer to like parts, in which:

FIG. 1 shows a cross section of an electric motor having an oil retainer assembly of the present invention.

FIG. 2 shows a detail partial view of the oil retainer assembly attached to motor shaft and abutting support bearing.

FIG. 3 shows a perspective view of the oil retainer assembly having a plurality of fan blades for cooling the motor assembly.

FIG. 4 shows a perspective view of the opposite side of the oil retainer assembly having a hub surface for sealing support bearing.

### DETAILED DESCRIPTION OF INVENTION

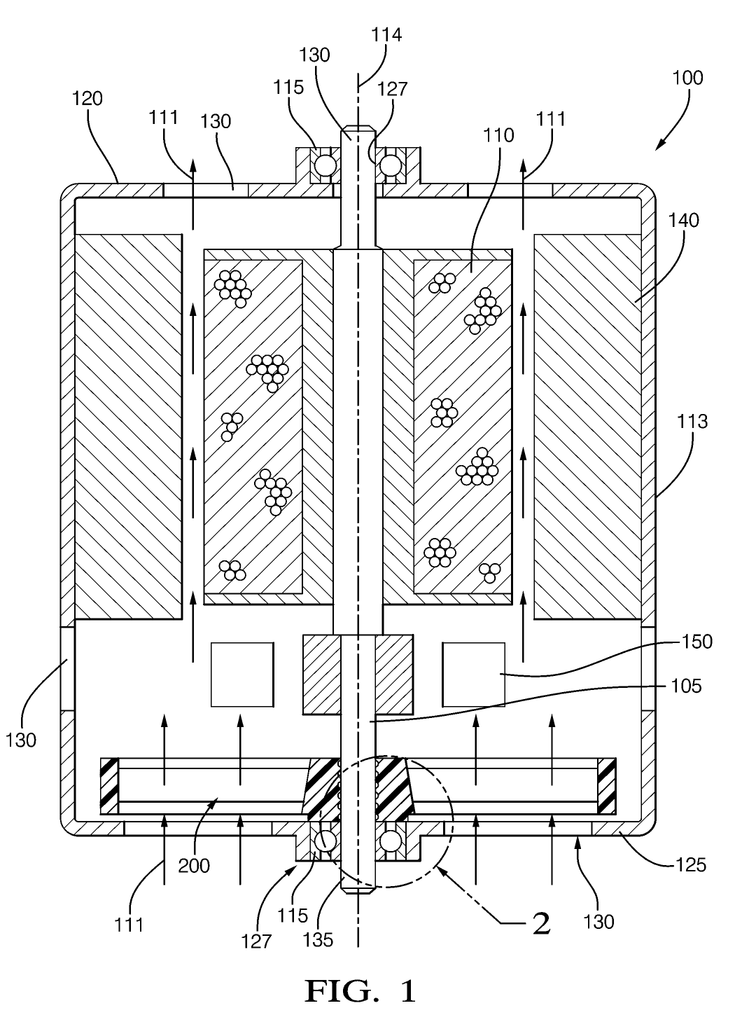

In accordance with a preferred embodiment of this invention, referring to FIGS. 1 through 4 is an electric motor assembly having an oil retainer cooling assembly 200. Shown in FIG. 1 is a cross sectional view of an electric motor 100 having an oil retainer cooling assembly 200 fixed onto motor shaft 105 between rotor assembly 110 and support bearing 115 within motor housing 113. Retainer cooling assembly 200 is a single piece unit used to retain oil in support bearing 115 and to induce air flow 111 within housing 113 to internally cool electric motor 100.

Electric motor 100 includes a housing 113 that is substantially tubular in shape along a longitudinal axis 114. Housing 113 includes a first end 120, which is the output end, and a second end 125 that is opposite that of first end 120. The first and second end 120, 125 of housing 113 is substantially perpendicular to longitudinal housing 113 and each includes an opening 127 that is concentrically located with longitudinal axis 114. Each opening 127 is adapted to accommodate a support bearing 115.

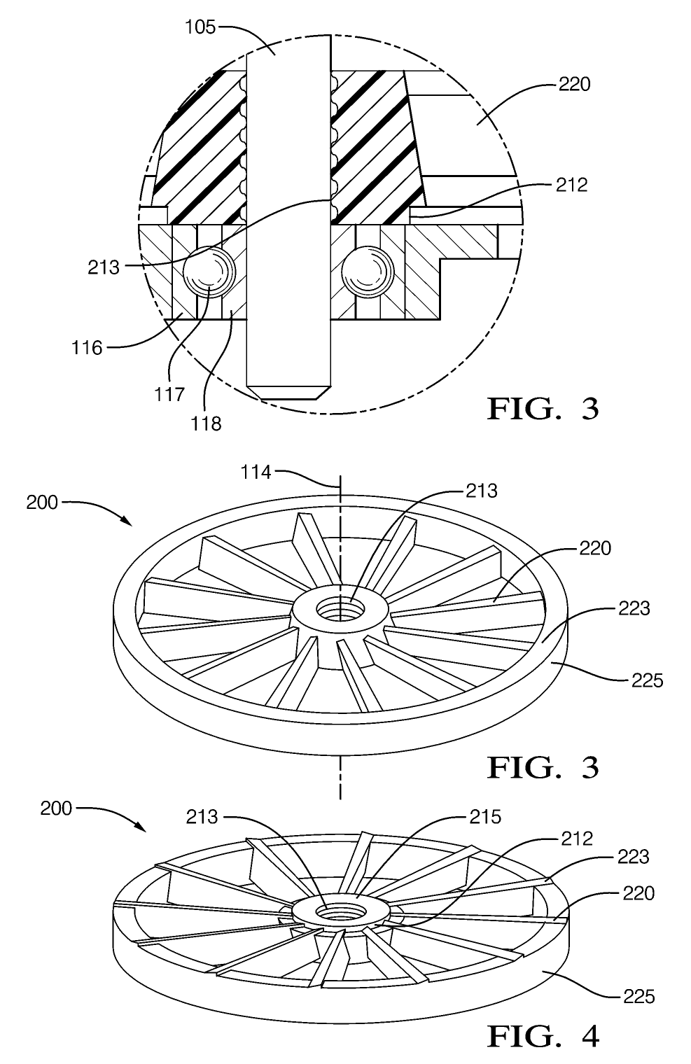

Disposed partially within motor housing 113 along longitudinal axis 114 is motor shaft 105. Motor shaft 105 includes an output end 130 that extends out from the opening of first end 120 of housing 113. Motor shaft 105 also includes a non-output end 135 that extends through opening 127 of second end 125 of housing 113. Output end 130 and non-output end 135 of the shaft are supported by support bearing 115. Support bearing 115 may be that of a typical cylindrical sleeve that is press fitted into opening 127 of the housing end, where the cylinder includes a bore to accommodate the support and rotation of the motor shaft 105. Shown in FIG. 3, the support bearing 115 may also be that of a more complex assembly that includes an outer member 116 that is press fitted in opening 127 of the housing end, an inner member 118 that is press fitted onto motor shaft 105, and friction reducing members 117 therebetween to allow the inner member 118 to rotate with respect to the outer member 116. To allow motor shaft 105 to rotate freely about longitudinal axis 114, support bearing 115 is provided with an oil lubricant or a heavier bearing grease.

Contained within housing 113 is a permanent magnet stator 140 surrounding rotor assembly 110. Rotor assembly 110 includes a winding of electrically conductive wire about a laminated stack armature and a commutator 150. Rotor assembly 110 is fixed on motor shaft 105. When an electric current is supplied to electric motor 100, stator 140 cooperates with rotor assembly 110 to induce motor shaft 105 to rotate about longitudinal axis 114.

Positioned between rotor assembly 110 and second end 125 of motor housing 113 is oil retainer cooling assembly 200. Oil retainer cooling assembly 200 is an integrated single piece unit that is used to retain the oil or grease within support bearing 115 from contaminating rotor assembly 110 and to induce air flow 111 to internally cool the electric motor 100.

Shown in FIGS. 3 and 4, oil retainer cooling assembly 100 includes a central hub 205. Central hub 205 includes hub bore 210 that is concentrically located with longitudinal axis 114 for the insertion of motor shaft 105. Hub bore 210 is adapted to be press fitted onto motor shaft 105, thereby inducing oil retainer cooling assembly 200 to rotate with the motor shaft 105. Hub bore 210 may also include teeth 213 or spindles to clinch onto the motor shaft 105 to maintain one to one rotation with motor shaft 105. As an alternative, the motor shaft 105 may contain teeth or spindle that is adapted to clinch onto the hub bore 210 to maintain non-slip contact between the hub 205 and motor shaft 105.

Best shown in FIGS. 3 and 4, extending radially from the hub 205 is a plurality of fan blades 220 tilted at an angle relative to the longitudinal axis 114 to induce air flow 111 within the housing 113. As an alternative, the fan blades 220 may extend axially (not shown), either in the direction toward output end 130 or second end 125 of motor housing 113. It is preferable that blades 220 are of symmetrical distance from hub 205 and spaced symmetrically about longitudinal axis 114 to prevent excess vibration during high speed rotation of oil retainer cooler assembly 200 caused by the high speed rotation of motor shaft 105. Each of fan blades 220 include a distal end 223 spaced apart from hub 205. Interconnecting two or more of distal ends 223 is a circumferential rim 225 to provide structural rigidity.

Shown in FIG. 4, hub 205 has a substantially circular cross section perpendicular to longitudinal axis 114 and includes a substantially flat hub surface 215 oriented toward support bearing 115. Hub surface 215 is adapted to be pressed against support bearing 115 to retain the oil or grease within support bearing 115 and to spin about support bearing 115 while maintaining contact at a high speed of rotation in which there is no degradation to hub surface 215 or support bearing 115. Hub 205 includes a longitudinally extending shoulder 212 to space a part hub surface 215 and fan blades 220. Shoulder 212 provides the space between the spinning fan blades 220 and second end 125 of motor housing 113 to ensure adequate internal air flow 111 within motor housing 113.

Oil retainer cooling assembly 200 rotates with shaft 105 causing fan blades 220 to induce air flow 111 within housing 113, thereby cooling electric motor 100. To aid in air flow 111, vents 130 are provided on either end of motor housing 113 to allow for the inlet of cool air and outlet of hot air. Vents 130 may also be provided in the side of the housing 113 to relieve any excess pressure built up from the fan compressing air within housing 113. As described herein above, the fan blade is tilted at an angle relative to longitudinal axis 114 to induce internal air flow 111 through housing 113 to internally cool the working mechanism of electric motor 100. The direction of air flow 111 is shown in FIG. 1. The preferred direction of air flow 111 is from second end 125 to first end 120, especially if there is play in motor shaft 105 in the longitudinal direction. If motor shaft 105 is capable of sliding within motor housing 113 in the longitudinal direction due to variability of built, it is preferred that fan blades 220 of oil retainer cooling assembly 200 induces air flow 111 from second end 125 to first end 120, because the inducement of air flow 111 in that direction will induce motor shaft 105 in the opposition direction toward second end 125. The inducement of motor shaft 105 toward second end 125 will also induce oil retainer cooling assembly 200 to seat more tightly against support bearing 115; and therefore, offers a greater seal.

The oil retainer cooling assembly 200 is manufactured from a non-electric conductive material such as polytetrafluoroethylene (PTFE), polypropylene, or other plastic resins to avoid causing any electrical problem by the debris and dust that could become loose during its life time. For simplicity of manufacturing, the oil retainer cooling assembly 200 may be formed by injection molding into a preformed die.

While this invention has been described in terms of the preferred embodiments thereof, it is not intended to be so limited, but rather only to the extent set forth in the claims that follow.

Having described the invention, it is claimed:

1. A motor assembly comprising;
a substantially tubular housing having a first end and a second end opposite of said first end disposed about a longitudinal axis;
a motor shaft disposed in said housing along said longitudinal axis, wherein said motor shaft includes an output end extending from said first end of housing and a non-output end extending from said second end of housing in a direction opposite of said output end;
a rotor assembly fixed onto said motor shaft within said housing;
a bearing assembly engaged to said second end and having a bore co-axial with said motor shaft for supporting said non-output end for said motor shaft rotation, wherein said bearing assembly includes an oil lubricant;
an oil retainer cooling assembly having a hub that includes a hub bore for the insertion and attachment of said hub to said motor shaft, and a plurality of fan blades protruding radially from said hub, whereby said oil retainer assembly rotates with said shaft causing said blades to induce air flow within said housing, thereby cooling said motor assembly.

2. The motor assembly of claim 1, wherein said hub further includes a hub surface that is substantially perpendicular to said longitudinal axis and in sealing contact with said bearing assembly.

3. The motor assembly of claim 1, wherein said fan blades extend substantially in the axial direction.

4. The motor assembly of claim 1, wherein said fan blades extend radially from said longitudinal axis.

5. The motor assembly of claim 4 wherein each of said fan blades includes a distal end extending in a direction away from said hub and a circumferential rim disposed about said longitudinal axis interconnecting said distal ends.

6. The motor assembly of claim 2, wherein said hub includes a shoulder between said hub surface and said fan blades, wherein said shoulder spaces said fan blades apart from said second end of housing.

7. The motor assembly of claim 2, wherein said oil retainer assembly comprises a polytetrafluoroethylene (PTFE).

8. The motor assembly of claim 2, wherein said oil retainer assembly comprises polypropylene.

9. The motor assembly of claim 3 wherein said housing includes a plurality of vents for air flow into and out of said housing.

10. The motor assembly of claim 4, wherein said motor shaft is slidably moveable along said longitudinal axis within said housing and said fan blades are pitched at an angle that induces said air flow toward said first end of housing, whereby said motor shaft rotation creates air flow toward said first end resulting in an equal and opposite force urging said hub against said bearing assembly to increase said sealing contact of said hub surface to said bearing assembly.
